(19) United States
(12) Patent Application Publication
(10) Pub. No.: US 2010/0310950 A1
(43) Pub. Date: Dec. 9, 2010

(54) Catalyst for fuel cell, ful cell systems including the same, and associated methods

(76) Inventors: Myoung-Ki Min, Suwon-si (KR); Geun-Seok Chai, Suwon-si (KR); Hee-Tak Kim, Suwon-si (KR); Tae-Yoon Kim, Suwon-si (KR); Sang-Il Han, Suwon-si (KR); Sung-Yong Cho, Suwon-si (KR); Kah-Young Song, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/656,262

(22) Filed: Jan. 22, 2010

(30) Foreign Application Priority Data
Jun. 5, 2009 (KR) 10-2009-0050031

(51) Int. Cl. H01M 8/18; B01J 23/42; B01J 23/28; B01J 23/32; B01J 23/60; B01J 23/72; B01J 21/18

(52) U.S. Cl. 429/423; 502/339; 502/313; 502/324; 502/326; 502/329; 502/331; 502/334; 502/185

(57) ABSTRACT

A catalyst for a fuel cell, a fuel cell system including the same, and associated methods, the catalyst including a platinum-metal alloy having a face-centered tetragonal structure, and a carrier, wherein the platinum-metal alloy shows a broad peak or a peak having two split tips at a 2θ of about 65 to about 75 degrees in an XRD pattern using a Cu—K α line, and the platinum-metal alloy is supported in the carrier and has an average particle size of about 1.5 to about 5 nm.

### BACKGROUND

1. Field

Embodiments relate to a catalyst for a fuel cell, a fuel cell system including the same, and associated methods.

2. Description of the Related Art

A fuel cell is a power generation system for producing electrical energy through an electrochemical oxidation-reduction (redox) reaction of an oxidant and hydrogen from a hydrocarbon-based material, e.g., methanol, ethanol, or natural gas.

Such a fuel cell may be a clean energy source that may replace fossil fuels. The fuel cell may include a stack having unit cells and may produce various ranges of power output. Because the fuel cell may have four to ten times higher energy density than a lithium battery, it has been highlighted as a small portable power source.

Fuel cells may include a polymer electrolyte membrane fuel cell (PEMFC) and a direct oxidation fuel cell (DOFC). The direct oxidation fuel cell may include a direct methanol fuel cell (DMFC) that uses methanol as a fuel.

The polymer electrolyte fuel cell may have a high energy density and high power output, but also may require careful handling of hydrogen gas. Also, accessory facilities, e.g., a fuel reformer for reforming methane or methanol, natural gas, and the like, may be needed to produce hydrogen.

### SUMMARY

Embodiments are directed to a catalyst for a fuel cell, a fuel cell system including the same, and associated methods, which substantially overcome one or more of the drawbacks, limitations, and/or disadvantages of the related art.

It is a feature of an embodiment to provide a catalyst for a fuel cell having high performance and stability.

At least one of the above and other features and advantages may be realized by providing a catalyst for a fuel cell including a platinum-metal alloy having a face-centered tetragonal structure, and a carrier, wherein the platinum-metal alloy shows a broad peak or a peak having two split tips at a 2θ of about 65 to about 75 degrees in an XRD pattern using a Cu—K α line, and the platinum-metal alloy is supported in the carrier and has an average particle size of about 1.5 nm to about 5 nm.

The metal may include at least one of V, Cr, Mn, Fe, Co, Ni, Cu, Zn, Ru, Rh, W, Os, Ir, Sn, Ga, Ti, and Mo.

The metal may include at least one of Fe and Co.

The platinum-metal alloy may include the platinum and the metal at a mole ratio of about 0.67:1 to about 1.5:1.

The platinum-metal alloy may have an average particle size of about 1.5 nm to about 3 nm.

The platinum-metal alloy may have a lattice constant of a=about 3.780 to about 3.880 Å and c=about 3.650 to about 3.810 Å.

The platinum-metal alloy may be present in an amount of about 20 to about 50 wt %, based on the total weight of alloy and carrier.

The carrier may include at least one of a carbon-based material and an inorganic particulate, the carbon-based material including at least one of graphite, denka black, ketjen black, acetylene black, carbon nanotubes, carbon nanofiber, carbon nanowire, carbon nanoballs, and activated carbon, and the inorganic particulate including at least one of alumina, silica, zirconia, and titania.

The catalyst may be used in a polymer electrolyte membrane fuel cell.

At least one of the above and other features and advantages may also be realized by providing a fuel cell system including a fuel supplier configured to supply a mixed fuel of fuel and water, a reformer configured to reform the mixed fuel and generate hydrogen gas, a stack configured to generate electric energy by performing an electrochemical reaction between the hydrogen gas supplied from the reforming part and an oxidizing agent, the stack having a catalyst including a platinum-metal alloy having a face-centered tetragonal structure, wherein the platinum-metal alloy shows a broad peak or a peak having two split tips at a 28 of about 65 to about 75 degrees in an XRD pattern using a Cu—K α line, is supported in a carrier, and has an average particle size of about 1.5 nm to about 5 nm, and an oxidizing agent supplier configured to supply the oxidizing agent to the reformer and the stack.

The metal may include at least one of V, Cr, Mn, Fe, Co, Ni, Cu, Zn, Ru, Rh, W, Os, Ir, Sn, Ga, Ti, and Mo.

The metal may include at least one of Fe and Co.

The platinum-metal alloy may include the platinum and the metal at a mole ratio of about 0.67:1 to about 1.5:1.

The platinum-metal alloy may have an average particle size of about 1.5 nm to about 3 nm.

The platinum-metal alloy may have a lattice constant of a=about 3.780 to about 3.880 Å and c=about 3.650 to about 3.810 Å.

The platinum-metal alloy may be included in the catalyst in an amount of about 20 to about 50 wt % based on the total amount of alloy and carrier.

The carrier may include at least one of a carbon-based material and an inorganic particulate, the carbon-based material including at least one of graphite, denka black, ketjen black, acetylene black, carbon nanotubes, carbon nanofiber, carbon nanowire, carbon nanoballs, and activated carbon and the inorganic particulate including at least one of alumina, silica, zirconia, and titania.

The stack may form a polymer electrolyte membrane fuel cell.

At least one of the above and other features and advantages may also be realized by providing a method of preparing a catalyst for a fuel cell including mixing a platinum raw material and a metal raw material in a solvent to provide a mixture, adding a carrier to the mixture, drying the mixture and carrier, and heating the dried mixture and carrier at a temperature of about 200° C. to about 700° C. to produce a catalyst having a face-centered tetragonal structure.

Heating the dried mixture and carrier may include heating in a gas atmosphere including hydrogen.

The gas atmosphere may include about 5 to about 100 volume % of hydrogen.

Heating the dried mixture and carrier may include heating under the gas atmosphere including hydrogen for about 0.5 to about 10 hours.

At least one of the above and other features and advantages may also be realized by providing a catalyst for a fuel cell prepared by a method including mixing a platinum raw material and a metal raw material in a solvent to provide a mixture, adding a carrier to the mixture, drying the mixture and carrier, and heating the dried mixture and carrier at a temperature of about 200° C. to about 700° C. to produce a catalyst having a face-centered tetragonal structure.

Heating the dried mixture and carrier may include heating in a gas atmosphere including hydrogen.

The gas atmosphere may include about 5 to about 100 volume % of hydrogen.

Heating the dried mixture and carrier may include heating under the gas atmosphere including hydrogen for about 0.5 to about 10 hours.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a schematic diagram of a fuel cell system in accordance with an embodiment;

FIG. 2 illustrates an exploded perspective view of a stack of a fuel cell system in accordance with an embodiment;

FIG. 3 illustrates a graph of an X-ray diffraction (XRD) pattern of the catalyst according to Example 1;

FIG. 4 illustrates a graph of an XRD pattern of the catalyst according to Example 2;

FIG. 5 illustrates a graph of an XRD pattern of the catalyst according to Example 3;

FIG. 6 illustrates a graph of an XRD pattern of the catalyst according to Comparative Example 1;

FIG. 7 illustrates a graph of an XRD pattern of the catalyst according to Comparative Example 2;

FIG. 8 illustrates a graph of an XRD pattern of the catalyst according to Comparative Example 3; and

FIG. 9 illustrates a graph of voltage-current of the fuel cells according to Examples 1 to 3 and Comparative Examples 1 to 3.

### DETAILED DESCRIPTION

Korean Patent Application No. 10-2009-0050031, filed on Jun. 5, 2009, in the Korean Intellectual Property Office, and entitled: “Catalyst for Fuel Cell and Fuel Cell System Including the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer is referred to as being “between” two layers, it can be the only layer between the two layers, or one or more intervening layers may also be present. Like reference numerals refer to like elements throughout.

In the polymer electrolyte fuel cell, a stack that generates electricity may include several unit cells stacked in multiple layers. Each unit cell may include a membrane-electrode assembly (MEA) and a separator (also referred to as a bipolar plate). The membrane-electrode assembly may include an anode (also referred to as a “fuel electrode” or an “oxidation electrode”) and a cathode (also referred to as an “air electrode” or a “reduction electrode”), which may be separated by a polymer electrolyte membrane.

Fuel may be supplied to the anode and adsorbed on catalysts of the anode. The fuel may be oxidized to produce protons and electrons. The electrons may be transferred into the cathode via an external circuit, and the protons may be transferred into the cathode through the polymer electrolyte membrane. In addition, an oxidant may be supplied to the cathode. Then, the oxidant, protons, and electrons may react on catalysts of the cathode to produce electricity along with water.

The catalyst used in the redox reaction of cathode may generally include platinum (Pt), but recently alloy catalysts have drawn attention as substitutes for the expensive platinum.

According to an embodiment, the catalyst for a fuel cell may include a platinum-metal alloy having a face-centered tetragonal structure. The face-centered tetragonal structure may include platinum and another metal in a molar ratio of approximately 1:1. The structure may be such that the metal is inserted into the lattice of the platinum. In other words, the platinum-metal alloy according to an embodiment may have a face-centered tetragonal structure.

When the platinum-metal alloy has the face-centered tetragonal structure, it may have excellent stability to, e.g., acid. For example, even if the alloy is agitated in a 1M sulfuric acid solution for one hour, it may have a very stable structure that is sufficient to avoid breaking. Accordingly, the catalyst may be stored for long time, due to its excellent stability to a sulfuric acid aqueous solution.

The platinum-metal alloy having the face-centered tetragonal structure may have a broad peak or a peak having two split tips at a 2θ value of about 65 to about 75 degrees in an X-Ray Diffraction (XRD) pattern using a Cu—K α line.

In the XRD pattern, the x-axis represents 2θ, and the y-axis represents the intensity of the peak. The broad peak may have a full width at half maximum, which is a full width at the point of 50% between the minimum and the maximum of the peak intensity, of about 4 degrees or more. In an implementation, the full width at half maximum may be about 4 to about 5 degrees at a 2θ value of about 65 to about 75 degrees.

The peak having two split tips may have a concave part having a minimum at a point of about 10% to about 100% of the peak intensity minimum at a 2θ value of about 65 to about 75 degrees. In addition, the peak having two split tips may include a peak overlapping two peaks. The peak having two split tips may be either symmetrical or asymmetrical.

The full width at half maximum of the broad peak, the minimum of the concave part of the peak having two split tips, and the peak shape may be observed and measured by carrying out noise reduction (also referring to as “smoothing”) one or more times. In an implementation, the noise reduction may be carried out 1 to 11 times. The noise may be reduced by using, e.g., an origin program, an X-pert program, and so on.

When metal is regularly inserted in a platinum lattice in a face-centered tetragonal structure, it may also show an ultra lattice peak in addition to the peak according to the face-centered tetragonal structure. Thus, it is understood that the ultra lattice peak indicates that platinum is highly and stably alloyed with the metal, and the high alloying degree may thereby be maintained at a lower temperature. The ultra lattice peak may be observed at least in part at a 2θ value of about 30 to about 40 degrees and about 50 to about 60 degrees in the XRD pattern using a Cu—K α line.

In order to provide the platinum-metal alloy with the desired structural characteristics, e.g., high alloying and stability, various manufacturing conditions may be beneficial. The alloy catalyst may generally refer to platinum being metal-bound with auxiliary metals. The structure of the alloy catalyst may be hard to control when two metals having different characteristics are mixed. In addition, it may be hard to uniformly maintain the bulk characteristic and the inter nano-particle characteristic, since it may be alloyed between nano-particles. Uniform manufacturing conditions, and various conditions will be described below.

The metal of the platinum-metal alloy may include, e.g., V, Cr, Mn, Fe, Co, Ni, Cu, Zn, Ru, Rh, W, Os, Ir, Sn, Ga, Ti, and/or Mo. In an implementation, the metal may include Fe and/or Co. In another implementation, the catalyst may include an alloy of Pt and Co. It may be easy to provide a regular alloy at around 650° C. and it is possible to maintain a high alloying degree at a low temperature.

According to an embodiment, it may be desirable to provide a mixed metal material having a uniform alloy composition in order to obtain a platinum-metal alloy having appropriate structural characteristics.

When the catalyst is uniformly alloyed in accordance with, e.g., a chemical method or irradiation, a distribution deviation at several parts is preferably less than about 5% in terms of EDS (energy dispersive spectroscopy) or EPMA (electron probe micro analyzer) results.

The platinum-metal alloy may have a mixed mole ratio of platinum and total amount of metal of about 0.67:1 to about 1.5:1. In other words, the mole ratio of Pt:M (wherein M is metal) may be about 0.67:1 to about 1:1.5. Maintaining the mixed mole ratio of platinum and metal at about 0.67:1 to about 1.5:1 may help ensure that the catalyst has the desired structural characteristics and may exhibit the ultra lattice peak, so the alloy catalyst may improve the high performance and stability. In an implementation, the mixed mole ratio may be about 0.8:1 to about 1.2:1.

Activity of the catalyst for the fuel cell may be related to a specific surface area of the platinum-metal alloy. Accordingly, providing a platinum-metal alloy having an average nano-particle size that increases the specific surface area of the platinum-metal alloy may be desirable. The platinum-metal alloy according to an embodiment may have an average particle size of about 5 nm or less. Maintaining the particle size of the platinum-metal alloy at about 5 nm or less may help ensure that the catalyst efficiency is improved such that it may be heated at a high temperature, improving the alloying degree due to the fine sized catalyst. Also, the active surface area of platinum may be increased to improve the activity, so it is possible to provide a fuel cell with high performance In an implementation, the particle size may be about 1.5 to about 5 nm. In another implementation, the particle size may be about 1.5 to about 3 nm.

The platinum-metal alloy may have a lattice constant of a=about 3.780 to about 3.880 Å and c=about 3.650 to about 3.810 Å. Maintaining the lattice constant of the platinum-metal alloy at a=about 3.780 to about 3.880 Å and c=about 3.650 to about 3.810 Å may help ensure that the catalyst is stably alloyed. In an implementation, the lattice constant may be a=about 3.780 to about 3.840 Å and c=about 3.680 to about 3.750 Å.

The platinum-metal alloy may be supported in a carrier. By supporting the alloy in a carrier, it is possible to decrease the catalyst particle size. Accordingly, it is possible to increase a reaction surface area of the catalyst.

The carrier may include, e.g., a carbon-based material including graphite, denka black, ketjen black, acetylene black, carbon nanotubes, carbon nanofiber, carbon nanowire, carbon nanoballs, and/or activated carbon, or inorganic material particulates including alumina, silica, zirconia, and/or titania. In an implementation, carbon-based material may be used.

When the platinum-metal alloy is supported in a carrier, it may be included in an amount of about 20 to about 50 wt %, based on the total weight of alloy and carrier. Maintaining the amount of the platinum-metal alloy in the carrier at about 20 to about 50 wt % may help ensure that it is possible to both use the catalyst in a polymer electrolyte membrane fuel cell (PEMFC) and to maintain the thickness of the catalyst layer at about 10 mm or less, thereby increasing the utilization rate of the catalyst. In an implementation, the alloy may be included in an amount of about 30 to about 50 wt %.

When the platinum-metal alloy according to an embodiment is supported in the carrier of carbon-based material, a mixed mole ratio of carbon-based material, platinum, and metal may be about 15.8:0.67:1 to about 117:1.51:1. Maintaining the mixed mole ratio of the carbon-based material, platinum, and metal at about 15.8:0.67:1 to about 117:1.51:1 may help ensure that it is possible to further improve performance and stability of the alloy catalyst. In an implementation the mixed mole ratio may be about 18:0.8:1 to about 98:1.2:1.

The platinum-metal alloy supported in the carrier may have a surface area of about 30 to about 120 m²/g. Maintaining the surface area of the alloy supported in the carrier at about 30 to about 120 m²/g may help ensure that the catalyst exhibits the alloy effect and good stability. In an implementation, the surface area may be about 40 to about 90 m²/g. In addition, in the alloy catalyst, the metal may occupy the position of the platinum to increase the surface area of the catalyst by the same amount as the platinum.

A catalyst according to an embodiment may be fabricated according to the following method.

A black type of catalyst not supported in a carrier may be prepared by, e.g., mixing a platinum raw material with a metal raw material in a solvent to provide a mixture, drying the mixture, and heating the dried mixture.

The catalyst supported in the carrier may be prepared by, e.g., mixing a platinum raw material with a metal raw material in a solvent to provide a mixture, supporting the mixture in a carrier and drying the same, and then heating the same. Alternatively, the method may include previously supporting platinum in a carrier, mixing the carrier supported with platinum with a solution including a metal raw material to provide a mixture, covering the carrier supported with platinum with metal, and heating the same. In an implementation, the raw material mixture and carrier may be irradiated with, e.g., a proton beam.

The alloying process may be better performed by further adding a sodium (Na)-metal salt to the carrier, so as to make the carrier alkaline.

The platinum raw material may include, e.g., H₂PtCl₆, PtCl₂, PtBr₂, (NH₃)₂Pt(NO₂)₂, K₂PtCl₆, K₂PtCl₄, K₂[Pt(CN)₄]3H₂O, K₂Pt(NO₂)₄, Na₂PtCl₆, Na₂[Pt(OH)₆], platinum acetyl acetonate, and/or ammonium tetrachloro platanate. In an implementation, the platinum raw material may include H₂PtCl₆.

The metal raw material may include any suitable metal-included compound, e.g., a metal halide, a metal nitrate, a metal hydrochloride, a metal sulfate, a metal acetate, a metal amine, and so on. In an implementation, the metal raw material may include a metal nitrate or metal hydrochloride.

The solvent may include, e.g., water, an alcohol such as methanol, ethanol, and isopropanol, or a mixture thereof.

The mixing ratio of the raw materials may be adjusted by considering the desired molar ratio of the metals in the final catalyst.

The drying process for the mixture to remove the solvent in the mixture may be performed by, e.g., ultra-sonication. In addition, pulverization may be performed after the drying process to provide a fine powdered mixture.

The heating process may be performed at about 200° C. to about 700° C. Maintaining the temperature of the heating process at about 200° C. to about 700° C. may help ensure that the raw materials are sufficiently decomposed to provide a uniform alloy. In an implementation the heating process may be performed at about 200° C. to about 300° C.

The heating process may be performed under a gas atmosphere including hydrogen. The gas atmosphere including hydrogen may include about 5 to about 100 volume % of hydrogen and about 0 to about 95 volume % of nitrogen. In an implementation, the gas atmosphere may include about 5 to about 50 volume % of hydrogen and about 50 to about 95 volume % of nitrogen. Generally, since platinum may exhibit hydrogen-philicity, the particle size may be increased under a heat and hydrogen atmosphere. However, the small particle size of platinum may be maintained by alloying under the gas atmosphere including about 5 to about 100 volume % of hydrogen.

The gas atmosphere may further include carbon monoxide and humidified nitrogen, thereby preventing the particles from agglomerating and reducing poisoning of the platinum.

The heating process may be performed for about 0.5 to about 10 hours. Performing the heating process at about 0.5 to about 10 hours may help ensure ease of carrying out the process and maintenance of the small particle size. In an implementation, the heating process may be performed for about 1 to about 5 hours.

After the heating process, the obtained product may be cooled. The cooling process may be performed in a slow process or quenching process. It may be beneficial to perform the cooling in a quenching process because it may provide a catalyst having an ultra lattice peak indicating, e.g., good alloying.

The quenching may be performed at a speed of about 10 to about 50° C./min. The cooling may be performed inside the reactor, rather than removing the reactants from the reactor. The product may be naturally cooled or may be cooled under a less cool condition. If the product is quickly quenched outside the reactor, it may cause problems in the reactor (heating furnace) or other safety problems. When the product is not quenched, it may cause it to naturally return to the original structure of the alloy catalyst.

After the heating process, a leaching step may be performed to selectively remove metal that is not alloyed. The leaching step may remove the metal that is not alloyed by adding an acid solution, e.g., sulfuric acid, phosphoric acid, and so on, to the alloy obtained after the heat treatment. The acid solution may have a concentration of about 0.5 to about 3 M. Maintaining the concentration of the acid solution at about 0.5 to about 3 M may help ensure that only metal that is not alloyed is removed. In an implementation, the concentration may be about 1 to about 2 M. The leaching step may be performed for about 0.1 to about 24 hours. Performing the leaching step for about 0.1 to about 24 hours may help ensure that only the metal that is not alloyed is removed. In an implementation, the leaching step may be performed for about 0.5 to about 5 hours.

It may be beneficial to adjust the thickness of the obtained catalyst of the catalyst layer to the reaction thickness (around 10 mm), so it is usable in a polymer electrolyte membrane fuel cell (PEMFC). In the case of a direct methanol fuel cell (DMFC), a lot of catalyst may be used to achieve the performance of the membrane-electrode assembly in a low carrying amount, thus the thickness of the catalyst layer may be thicker. Generally, the direct methanol fuel cell may include a catalyst supported in an amount of about 60 wt % or more.

The catalyst for a fuel cell may be included in a cathode.

It is possible to provide a platinum-metal catalyst having a face-centered tetragonal structure by controlling various conditions, so the platinum-metal catalyst may ensure desired high stability and performance.

According to another embodiment, a fuel cell system including the catalyst for a fuel cell is provided, and is described below.

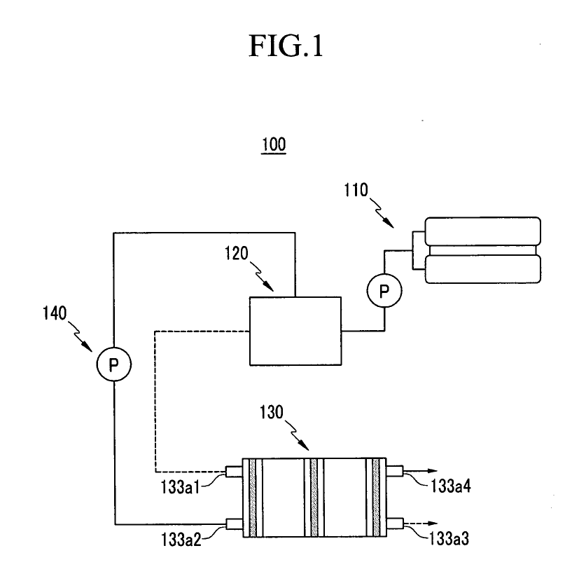

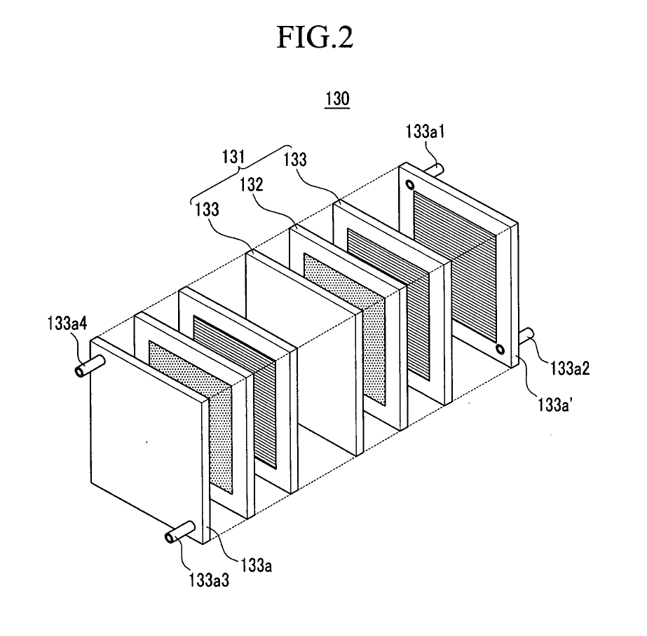

FIG. 1 illustrates a schematic diagram of a fuel cell system in accordance with an embodiment. FIG. 2 illustrates an exploded perspective view of a stack of a fuel cell system in accordance with an embodiment.

Referring to FIGS. 1 and 2, a fuel cell system 100 of an embodiment may include a fuel supplier 110 to supply a mixed fuel of fuel and water, a reformer 120 to reform the mixed fuel and generate hydrogen, a stack 130 having a catalyst to generate electrical energy by performing an electrochemical reaction on an oxidizing agent and the hydrogen gas supplied from the reformer, and an oxidizing agent supplier 140 to supply the oxidizing agent to the reformer 120 and the stack 130.

Furthermore, the fuel cell system 100 of an embodiment may include a plurality of unit cells 131 to induce an oxidation-reduction reaction between reforming gases, including hydrogen gas from the reformer 120 and oxygen from the oxidizing agent, to generate electrical energy.

Each unit cell 131 may serve as a unit for generating electricity and may include a membrane-electrode assembly 132 for oxidizing and reducing the reforming gases including hydrogen gas and oxygen from the oxidizing agent. Each unit cell may also include separators 133 (also referred to as bipolar plates) for supplying the hydrogen and oxidizing agent to the membrane-electrode assembly 132. The separators 133 may be arranged on sides of the membrane-electrode assembly 132. Separators that are respectively located at most exterior sides of the stack may be referred to as end plates 133a and 133a′.

The membrane-electrode assembly 132 may include an anode electrode and a cathode that form sides of the assembly and hold an electrolyte membrane therebetween.

The anode supplied with hydrogen gas through the separator 133 may include a catalytic layer that converts the hydrogen gas into electrons and hydrogen ions via an oxidation reaction and a gas diffusion layer that smoothly moves the electrons and hydrogen ions.

The cathode supplied with oxidizing agents through the separator 133 may include a catalytic layer that converts oxygen from oxidizing agents into electrons and oxygen ions via a reduction reaction and a gas diffusion layer that smoothly moves the electrons and oxygen ions. The electrolyte membrane may be a solid polymer electrolyte and may be about 10 to about 200 μm-thick. The electrolyte membrane may serve as an ion exchanging membrane that moves the hydrogen ions generated from the catalytic layer of the anode to the catalytic layer of the cathode.

The catalyst of the catalyst layer may include the platinum-metal alloy according to an embodiment.

The end plate 133a of the separators may include a first supply tube 133a1 having a pipe shape for injecting the hydrogen gas from the reformer and a second supply tube 133a2 having a pipe shape for injecting the oxygen gas. The other end plate 133a′ may include a first discharge tube 133a3 for discharging the remaining hydrogen gas that does not react in the plurality of unit cells 131 to the outside and a second discharge tube 133a4 for discharging the remaining oxidizing agent that does not react in the plurality of unit cells 131 to the outside.

The fuel cell system may improve the performance because the catalyst having high performance and stability is employed.

The following examples illustrate the embodiments in detail. These examples, however, should not in any sense be interpreted as limiting the scope.

### Manufacturing Catalyst for Fuel Cell

### Example 1

In order to provide an alloy catalyst in which platinum (Pt) and cobalt (Co) were present in a molar ratio of 1:1, a platinum acid solution (H₂PtCl₆, Aldrich) and cobalt nitrate (Co(NO₃)₂, Aldrich) were dissolved in distilled water in a molar ratio. A catalyst carrier of ketjen black was then dispersed at 50 wt % and irradiated to provide a catalyst. The irradiation source was a proton beam, and the solution was irradiated with energy of 45 MeV, 5 μA, for 10 minutes. The catalyst was dried at 100° C. for one hour and heated at 300° C. for one hour under a mixed gas of hydrogen and nitrogen (10 volume % of hydrogen, 90 volume % of nitrogen) to provide a catalyst for a fuel cell. The obtained catalyst had an average particle size of 3 nm, a face-centered tetragonal structure, and a lattice constant of a=3.796 Å and c=3.680 Å.

### Example 2

In order to provide an alloy catalyst in which platinum (Pt) and cobalt (Co) were present in a molar ratio of 1:1, a platinum acid solution (H₂PtCl₆, Aldrich) and cobalt nitrate (Co(NO₃)₂, Aldrich) were dissolved in distilled water in a molar ratio. A catalyst carrier of ketjen black was then dispersed at 50 wt % and irradiated to provide a catalyst. The irradiation source was a proton beam, and the solution was irradiated with energy of 45 MeV, 5 μA, for 10 minutes. The catalyst was dried at 100° C. for one hour and heated at 200° C. for one hour under a mixed gas of hydrogen and nitrogen (10 volume % of hydrogen, 90 volume % of nitrogen) to provide a catalyst for a fuel cell. The obtained catalyst had an average particle size of 2.7 nm, a face-centered tetragonal structure, and a lattice constant of a=3.802 Å and c=3.780 Å.

### Example 3

In order to provide an alloy catalyst in which platinum (Pt) and cobalt (Co) were present in a molar ratio of 1:1, a platinum acid solution (H₂PtCl₆, Aldrich) and cobalt nitrate (Co(NO₃)₂, Aldrich) were dissolved in distilled water in a molar ratio. A catalyst carrier of ketjen black was then dispersed at 50 wt % and irradiated to provide a catalyst. The irradiation source was a proton beam, and the solution was irradiated with energy of 45 MeV, 5 μA, for 10 minutes. The catalyst was dried at 100° C. for one hour and heated at 650° C. for one hour under a mixed gas of hydrogen and nitrogen (10 volume % of hydrogen, 90 volume % of nitrogen) to provide a catalyst for a fuel cell. The obtained catalyst had an average particle size of 5 nm, a face-centered tetragonal structure, and a lattice constant of a=3.790 Å and c=3.680 Å.

### Comparative Example 1

In order to provide an alloy catalyst in which platinum (Pt) and cobalt (Co) were present in a molar ratio of 1:1, a platinum acid solution (H₂PtCl₆, Aldrich) and cobalt nitrate (Co(NO₃)₂, Aldrich) were dissolved in distilled water in a molar ratio. A catalyst carrier of ketjen black was then dispersed at 50 wt % and irradiated to provide a catalyst. The irradiation source was a proton beam, and the solution was irradiated with energy of 45 MeV, 5 μA, for 10 minutes. The catalyst was dried at 100° C. for one hour and heated at 150° C. for one hour under a mixed gas of hydrogen and nitrogen (10 volume % of hydrogen, 90 volume % of nitrogen) to provide a catalyst (PtCO_{1.5}) for a fuel cell. The obtained catalyst had an average particle size of 2.7 nm, a face centered cubic structure, and a lattice constant of a=3.910 Å.

### Comparative Example 2

In order to provide an alloy catalyst in which platinum (Pt) and cobalt (Co) were present in a molar ratio of 1:1, a platinum acid solution (H₂PtCl₆, Aldrich) and cobalt nitrate (Co(NO₃)₂, Aldrich) were dissolved in distilled water in a molar ratio. A catalyst carrier of ketjen black was then dispersed at 50 wt % and irradiated to provide a catalyst. The irradiation source was a proton beam, and the solution was irradiated with energy of 45 MeV, 5 μA, for 10 minutes. The catalyst was dried at 100° C. for one hour and heated at 900° C. for one hour under a mixed gas of hydrogen and nitrogen (10 volume % of hydrogen, 90 volume % of nitrogen) to provide a catalyst (PtCO₉) for a fuel cell. The obtained catalyst had an average particle size of 10 nm, a face-centered tetragonal structure, and a lattice constant of a=3.802 Å and c=3.780 Å.

### Comparative Example 3

In order to provide an alloy catalyst in which platinum (Pt) and cobalt (Co) were present in a molar ratio of 3:1, a platinum acid solution (H₂PtCl₆, Aldrich) and cobalt nitrate (Co(NO₃)₂, Aldrich) were dissolved in distilled water in a molar ratio. A catalyst carrier of ketjen black was then dispersed at 50 wt % and irradiated to provide a catalyst. The irradiation source was a proton beam, and the solution was irradiated in energy of 45 MeV, 5 μA, for 10 minutes. The catalyst was dried at 100° C. for one hour and heated at 300° C. for one hour under a mixed gas of hydrogen and nitrogen (10 volume % of hydrogen, 90 volume % of nitrogen) to provide a catalyst (Pt₃Co) for a fuel cell. The obtained catalyst had an average particle size of 3 nm, a face centered cubic structure, and a lattice constant of a=3.878 Å.

Analyzing Stability of Catalyst Structure

In order to analyze the stability of the catalyst structure, each catalyst obtained from Examples 1 to 3 and Comparative Examples 1 to 3 was agitated in a 1 M sulfuric acid solution for one hour.

From the result, it is understood that each catalyst obtained from Examples 1 to 3 had a very stable structure since the obtained catalyst structure was not broken after the acid treatment. Each catalyst had a highly alloyed and ordered structure, and it is anticipated that Co was less eluted during the acid treatment to maintain the structure. The catalyst obtained from Example 1 had a mixed mole ratio of Pt:Co of 1.8:1 after the acid treatment. Compared to the mixed mole ratio of 1:1 prior to acid treatment, the Pt amount was decreased by about 17%, although the ratio of Co was also decreased.

On the other hand, the structure of each catalyst obtained from Comparative Examples 1 to 3 was broken and distorted, due to an unstable structure. This may be caused by dissolution and removal of a considerable amount of Co during the acid treatment.

In Comparative Example 1, the catalyst was insufficiently alloyed because it was heated at too low of a temperature. The lattice constant was too high at a=3.910 Å, and it did not have the face-centered tetragonal structure. That is, considering the composition ratio, it should have the face-centered tetragonal structure, but instead, it had a face-centered cubic structure, indicating that Co was insufficiently alloyed and was present as free atoms of Co.

In Comparative Example 2, because the catalyst was heated at too high a temperature, excessive Co was present on the surface. Therefore the mole ratio of the catalyst was not about 1:1, due to excessive Co present on the surface. The stability may be deteriorated due to the amount of Co present on the surface.

In the case of Comparative Example 3, the catalyst had an unstable structure instead of the face-centered tetragonal structure because the alloy had a mole ratio of platinum (Pt) and cobalt (Co) of 3:1.

XRD Pattern Analysis Result

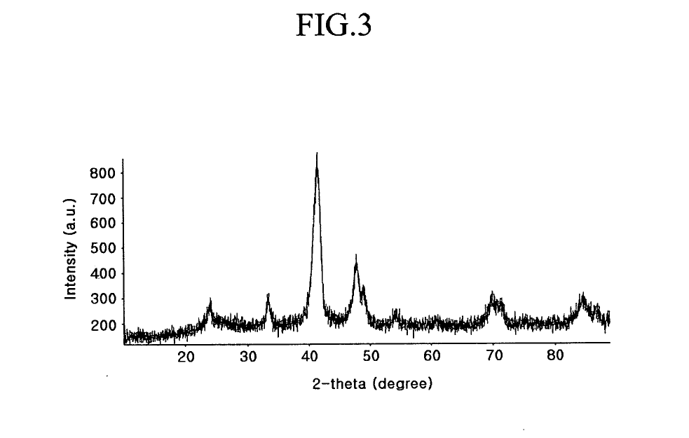

Each catalyst obtained from Examples 1 to 3 and Comparative Examples 1 to 3 was measured for XRD pattern using a Cu—K α line and the results are shown in FIG. 3 to FIG. 8.

FIG. 3 illustrates a graph showing the XRD pattern of the catalyst obtained from Example 1. Referring to FIG. 3, the catalyst obtained from Example 1 had a peak having two split tips at a 2θ value of 65 to 75 degrees. The platinum-metal alloy had high stability due to the face-centered tetragonal structure.

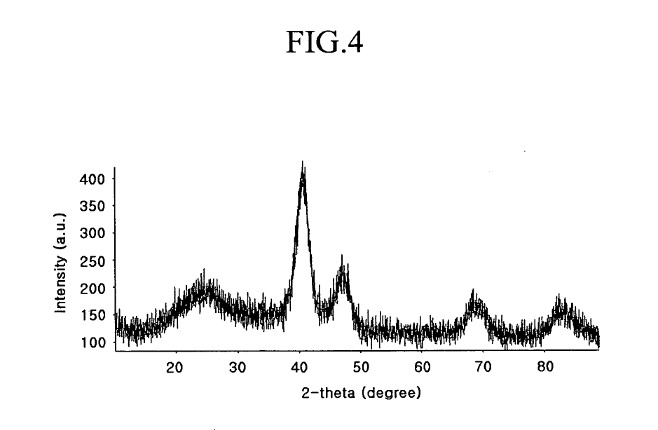

FIG. 4 illustrates a graph showing the XRD pattern of the catalyst obtained from Example 2. Referring to FIG. 4, the catalyst obtained from Example 2 had a peak having two split tips at a 2θ value of 65 to 75 degrees. Since the heat treatment temperature was relatively low, the ultra lattice peak was not clearly shown compared to that of FIG. 3. The catalyst had a small particle size.

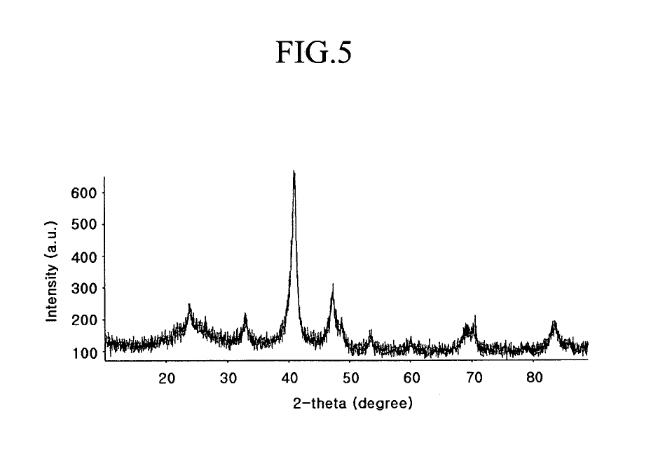

FIG. 5 illustrates a graph showing the XRD pattern of the catalyst obtained from Example 3. Referring to FIG. 5, the diffraction peaks were clearly shown since the catalyst obtained from Example 3 was heated at a high temperature, and it had excellent crystallinity, but a relatively large particle size. That is, it showed a peak having two split tips at a 2θ value of 65 to 75 degrees and an ultra lattice peak at 30 to 40 degrees and 50 to 60 degrees.

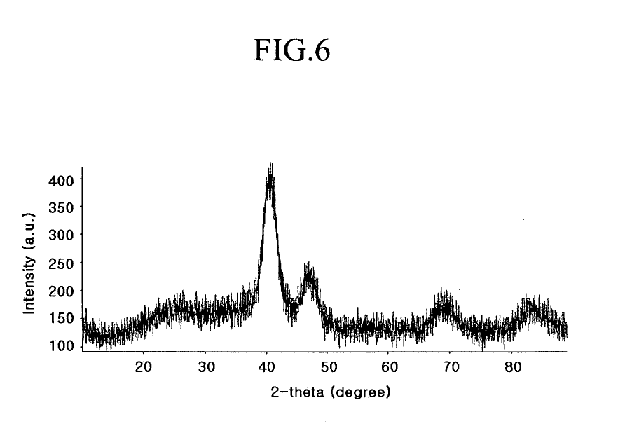

FIG. 6 illustrates a graph showing the XRD pattern of the catalyst obtained from Comparative Example 1. Referring to FIG. 6, it may be seen that the catalyst obtained from Comparative Example 1 had only one peak at a 20 value of 65 to 75 degrees (full width at half maximum: about 3.8 degrees). In addition, it was randomly alloyed, thereby deteriorating stability. Since the catalyst was heated at an excessively low temperature, thereby deteriorating the crystallinity and decreasing the alloying degree, the lattice constant was a=3.910 Å.

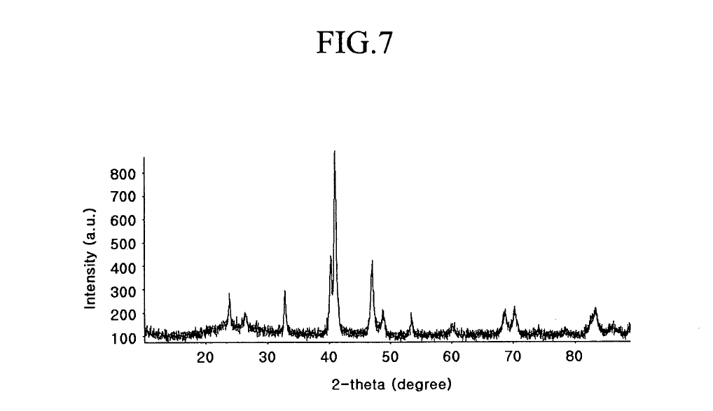

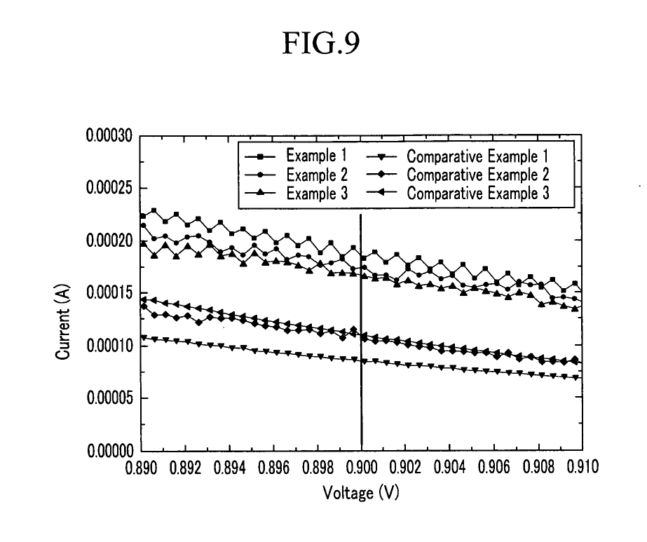

FIG. 7 illustrates a graph showing the XRD pattern of the catalyst obtained from Comparative Example 2. Referring to FIG. 7, the catalyst obtained from Comparative Example 2 had a peak having two split tips at a 2θ value of 65 to 75 degrees. The obtained platinum-metal alloy had a face-centered tetragonal structure, so it is understood that it had a high stability. However, the catalyst obtained from Comparative Example 2 had an excessively large particle size, thereby deteriorating catalytic performance (see FIG. 9). Since the particle size was at least about 10 nm, the catalyst active surface area was decreased, thereby deteriorating the performance.

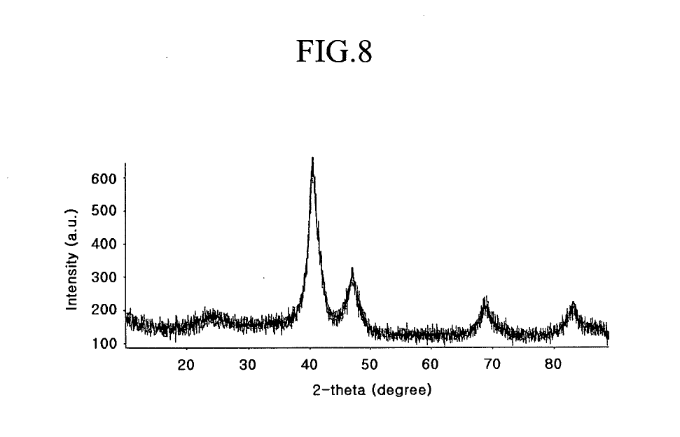

FIG. 8 illustrates a graph showing the catalyst obtained from Comparative Example 3. Referring to FIG. 8, since the catalyst obtained from Comparative Example 3 had a mole ratio of 3:1, it had one peak (full width at half maximum: about 2.5 degrees) instead of a peak having two split tips at a 2θ value of 65 to 75 degrees, indicating lower stability.

<Manufacturing Fuel Cell>

Each catalyst obtained from Examples 1 to 3 and Comparative Examples 1 to 3 was added to a mixed solvent of water and isopropyl alcohol mixed in a volume ratio of 10:80. Then, 25 parts by weight of a sulfonated tetrafluoroethylene based fluoropolymer-copolymer solution (Nafion 1100 EW, manufactured by Dupont) was mixed therein, and the mixture was treated with ultrasonic waves and uniformly agitated to provide a composition for a catalyst layer.

The obtained composition for a catalyst layer was sprayed on a tetrafluoroethylene (TEFLON)-treated carbon paper substrate (cathode/anode=SGL 31BC/10DA; manufactured by SGL Carbon Group) to provide a cathode. An anode was fabricated using a PtRu black catalyst (HiSPEC 6000, manufactured by Johnson Matthey) in accordance with the same process. For the anode, the catalyst layer was coated in a loading amount of 6 mg/cm², and for the cathode, the catalyst layer was coated in a loading amount of 4 mg/cm².

The electrodes were laminated on respective surfaces of a commercial polymer electrolyte membrane for a fuel cell (catalyst Feated membrane-type fuel cell MEA; manufactured by DuPont; Nafion 115 Membrane) to provide a layer/electrode assembly. The obtained layer/electrode assembly was inserted between gaskets, and inserted between two separators having a gas flow channel and a cooling channel, and then pressed between copper end plates to provide a half-cell.

Battery Performance Result

Each half cell obtained from Examples 1 to 3 and Comparative Examples 1 to 3 was driven in a sulfuric acid solution, and the battery characteristics were analyzed. The results are illustrated in FIG. 9. FIG. 9 illustrates a voltage-current graph of each fuel cell obtained from Examples 1 to 3 and Comparative Examples 1 to 3.

As illustrated in FIG. 9, it may be seen that each fuel cell obtained from Examples 1 to 3 had a higher current value at the same voltage, particularly, 0.900 V, compared to each Comparative Example, indicating that the performance of the fuel cell was further improved.

Research on alloy catalysts generally concentrate on ways to overcome performance deterioration caused by reducing amounts of platinum. Also, stability may deteriorate when the alloy catalyst is insufficiently alloyed. Particularly, the stability deterioration may be more serious in a polymer electrolyte membrane fuel cell, so developing an alloy catalyst having high stability may be desirable.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A catalyst for a fuel cell, comprising:
a platinum-metal alloy having a face-centered tetragonal structure; and
a carrier, wherein:
the platinum-metal alloy shows a broad peak or a peak having two split tips at a 2θ of about 65 to about 75 degrees in an XRD pattern using a Cu—K α line, and
the platinum-metal alloy is supported in the carrier and has an average particle size of about 1.5 nm to about 5 nm.

2. The catalyst for a fuel cell as claimed in claim 1, wherein the metal includes at least one of V, Cr, Mn, Fe, Co, Ni, Cu, Zn, Ru, Rh, W, Os, Ir, Sn, Ga, Ti, and Mo.

3. The catalyst for a fuel cell as claimed in claim 2, wherein the metal includes at least one of Fe and Co.

4. The catalyst for a fuel cell as claimed in claim 2, wherein the platinum-metal alloy includes the platinum and the metal at a mole ratio of about 0.67:1 to about 1.5:1.

5. The catalyst for a fuel cell as claimed in claim 1, wherein the platinum-metal alloy has an average particle size of about 1.5 nm to about 3 nm.

6. The catalyst for a fuel cell as claimed in claim 1, wherein the platinum-metal alloy has a lattice constant of a=about 3.780 to about 3.880 Å and c=about 3.650 to about 3.810 Å.

7. The catalyst for a fuel cell as claimed in claim 1, wherein the platinum-metal alloy is present in an amount of about 20 to about 50 wt %, based on the total weight of alloy and carrier.

8. The catalyst for a fuel cell as claimed in claim 1, wherein the carrier includes at least one of a carbon-based material and an inorganic particulate, the carbon-based material including at least one of graphite, denka black, ketjen black, acetylene black, carbon nanotubes, carbon nanofiber, carbon nanowire, carbon nanoballs, and activated carbon, and the inorganic particulate including at least one of alumina, silica, zirconia, and titania.

9. The catalyst for a fuel cell as claimed in claim 1, wherein the catalyst is used in a polymer electrolyte membrane fuel cell.

10. A fuel cell system, comprising:
a fuel supplier configured to supply a mixed fuel of fuel and water;
a reformer configured to reform the mixed fuel and generate hydrogen gas;
a stack configured to generate electric energy by performing an electrochemical reaction between the hydrogen gas supplied from the reforming part and an oxidizing agent, the stack having a catalyst including a platinum-metal alloy having a face-centered tetragonal structure, wherein the platinum-metal alloy shows a broad peak or a peak having two split tips at a 2θ of about 65 to about 75 degrees in an XRD pattern using a Cu—K α line, is supported in a carrier, and has an average particle size of about 1.5 nm to about 5 nm; and
an oxidizing agent supplier configured to supply the oxidizing agent to the reformer and the stack.

11. The fuel cell system as claimed in claim 10, wherein the metal includes at least one of V, Cr, Mn, Fe, Co, Ni, Cu, Zn, Ru, Rh, W, Os, Ir, Sn, Ga, Ti, and Mo.

12. The fuel cell system as claimed in claim 10, wherein the metal includes at least one of Fe and Co.

13. The fuel cell system as claimed in claim 10, wherein the platinum-metal alloy includes the platinum and the metal at a mole ratio of about 0.67:1 to about 1.5:1.

14. The fuel cell system as claimed in claim 10, wherein the platinum-metal alloy has an average particle size of about 1.5 nm to about 3 nm.

15. The fuel cell system as claimed in claim 10, wherein the platinum-metal alloy has a lattice constant of a=about 3.780 to about 3.880 Å and c=about 3.650 to about 3.810 Å.

16. The fuel cell system as claimed in claim 10, wherein the platinum-metal alloy is included in the catalyst in an amount of about 20 to about 50 wt % based on the total amount of alloy and carrier.

17. The fuel cell system as claimed in claim 10, wherein the carrier includes at least one of a carbon-based material and an inorganic particulate, the carbon-based material including at least one of graphite, denka black, ketjen black, acetylene black, carbon nanotubes, carbon nanofiber, carbon nanowire, carbon nanoballs, and activated carbon and the inorganic particulate including at least one of alumina, silica, zirconia, and titania.

18. The fuel cell system as claimed in claim 10, wherein the stack forms a polymer electrolyte membrane fuel cell.

19. A method of preparing a catalyst for a fuel cell, comprising:
mixing a platinum raw material and a metal raw material in a solvent to provide a mixture;
adding a carrier to the mixture;
drying the mixture and carrier; and
heating the dried mixture and carrier at a temperature of about 200° C. to about 700° C. to produce a catalyst having a face-centered tetragonal structure.

20. The method as claimed in claim 19, wherein heating the dried mixture and carrier includes heating in a gas atmosphere including hydrogen.

21. The method as claimed in claim 20, wherein the gas atmosphere includes about 5 to about 100 volume % of hydrogen.

22. The method as claimed in claim 20, wherein heating the dried mixture and carrier includes heating under the gas atmosphere including hydrogen for about 0.5 to about 10 hours.

23. A catalyst for a fuel cell prepared by a method comprising:
mixing a platinum raw material and a metal raw material in a solvent to provide a mixture;
adding a carrier to the mixture;
drying the mixture and carrier; and
heating the dried mixture and carrier at a temperature of about 200° C. to about 700° C. to produce a catalyst having a face-centered tetragonal structure.

24. The catalyst for a fuel cell as claimed in claim 23, wherein heating the dried mixture and carrier includes heating in a gas atmosphere including hydrogen.

25. The catalyst for a fuel cell as claimed in claim 24, wherein the gas atmosphere includes about 5 to about 100 volume % of hydrogen.

26. The catalyst for a fuel cell as claimed in claim 24, wherein heating the dried mixture and carrier includes heating under the gas atmosphere including hydrogen for about 0.5 to about 10 hours.
